(19) United States
(12) Patent Application Publication
(10) Pub. No.: US 2026/0246849 A1
(43) Pub. Date: Aug. 20, 2026

(54) METHODS AND SYSTEMS OF GENERATING A TICKET ASSOCIATED WITH A USER BASED ON A CALL

(71) Applicant: MSP Process, LLC, Madisonville, LA (US)

(72) Inventors: Patrick Leonard, Madisonville, LA (US); Greg Celmainis, North Vancouver (CA)

(21) Appl. No.: 19/544,846

(22) Filed: Feb. 19, 2026

Related U.S. Application Data
(60) Provisional application No. 63/760,510, filed on Feb. 19, 2025.

(51) Int. Cl. H04L 67/50; G06Q 30/016; H04L 9/40

(52) U.S. Cl. CPC H04L 67/535; G06Q 30/016; H04L 63/08

(57) ABSTRACT

The present disclosure provides a method of generating a ticket based on a call. Further, the method may include receiving a user call data from a user device. Further, the user call data corresponds to the call associated with the user. Further, the method may include generating an enquiry data based on the user call data. Further, the enquiry data corresponds to an enquiry in relation to the user. Further, the enquiry data may be further configured to be presented on a user-presentation device associated with the user device. Further, the user device further includes a user-input device which may be configured for receiving a user enquiry-response data in response to the enquiry data. Further, the method may include receiving the user enquiry-response data from the user device. Further, the method may include generating a response-based ticket data based on the user enquiry-response data. Further, the response-based ticket data corresponds to the ticket in relation to the user call data. Further, the method may include storing, using a storage device, the response-based ticket data.

The current application claims a priority to the U.S. Provisional Patent pplication Ser. No. 63/760,510 filed Feb. 19, 2025.

### FIELD OF DISCLOSURE

The present invention relates to the field of data processing. More specifically, the present disclosure relates to systems and methods of generating a ticket associated with a user based on a call.

### BACKGROUND

Currently, organizations use phone-based customer support for secure, real-time communications. However, common pain points exist such as fragmented MFA, multi-CRM complexity, limited post-call engagement, inefficient escalation of user query and voice data storage. As companies strive to reduce operational costs and improve the customer experience, there is a need for an end-to-end voice solution. Therefore, there is a need for improved methods and systems of generating a ticket associated with a user based on a call.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of generating a ticket associated with a user based on a call. Further, the method may include receiving, using a communication device, a user call data from a user device associated with the user. Further, the user call data corresponds to the call associated with the user. Further, the method may include generating, using a processing device, an enquiry data based on the user call data. Further, the enquiry data corresponds to an enquiry in relation to the user. Further, the method may include transmitting, using the communication device, the enquiry data to the user device. Further, the enquiry data may be further configured to be presented on a user-presentation device associated with the user device. Further, the user device further includes a user-input device which may be configured for receiving a user enquiry-response data in response to the enquiry data. Further, the user device further includes a user-communication device which may be configured for transmitting the user enquiry-response data to the communication device. Further, the method may include receiving, using the communication device, the user enquiry-response data from the user device. Further, the method may include generating, using the processing device, a response-based ticket data based on the user enquiry-response data. Further, the response-based ticket data corresponds to the ticket in relation to the user call data. Further, the method may include storing, using a storage device, the response-based ticket data.

The present disclosure provides a system of generating a ticket associated with a user based on a call. Further, the system may include a communication device. Further, the communication device may be configured for receiving a user call data from a user device associated with the user. Further, the user call data corresponds to the call associated with the user. Further, the communication device may be configured for transmitting an enquiry data to the user device. Further, the enquiry data may be further configured to be presented on a user-presentation device associated with the user device. Further, the user device further includes a user-input device which may be configured for receiving a user enquiry-response data in response to the enquiry data. Further, the user device further includes a user-communication device which may be configured for transmitting the user enquiry-response data to the communication device. Further, the communication device may be configured for receiving, using the communication device, the user enquiry-response data from the user device. Further, the system may include a processing device. Further, the processing device may be configured for generating the enquiry data based on the user call data. Further, the enquiry data corresponds to an enquiry in relation to the user. Further, the processing device may be configured for generating a response-based ticket data based on the user enquiry-response data. Further, the response-based ticket data corresponds to the ticket in relation to the user call data. Further, the system may include a storage device which may be configured for storing the response-based ticket data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of generating a ticket associated with a user based on a call, in accordance with some embodiments.

FIG. 3B illustrates a continuation of the flowchart of the method 300 of generating a ticket associated with a user based on a call, in accordance with some embodiments.

FIG. 4 illustrates a flowchart of a method 400 of generating a ticket associated with a user based on a call including generating, using the processing device 904, a ticket confirmation data, in accordance with some embodiments.

FIG. 5 illustrates a flowchart of a method 500 of generating a ticket associated with a user based on a call including determining, using the processing device 904, a CRM type, in accordance with some embodiments.

FIG. 6 illustrates a flowchart of a method 600 of generating a ticket associated with a user based on a call including identifying, using the processing device 904, a context associated with the user call data, in accordance with some embodiments.

FIG. 7 illustrates a flowchart of a method 700 of generating a ticket associated with a user based on a call including generating, using the processing device 904, a follow-up data, in accordance with some embodiments.

FIG. 8 illustrates a flowchart of a method 800 of generating a ticket associated with a user based on a call including retrieving, using the storage device 906, a user-historical data corresponding to a history associated with the user, in accordance with some embodiments.

FIG. 9 illustrates a block diagram of a system 900 of generating a ticket associated with a user based on a call, in accordance with some embodiments.

FIG. 10 illustrates a flowchart of a method 1000 of generating a ticket associated with a user based on a call including determining, using the processing device 904, at least one of a user query date data and the CRM type, in accordance with some embodiments.

FIG. 11 illustrates a flowchart of a method 1100 of generating a ticket associated with a user based on a call including generating, using the processing device 904, a follow up call data corresponding to follow up call associated with the user, in accordance with some embodiments.

FIG. 12 illustrates a flowchart of a method 1200 of generating a ticket associated with a user based on a call including generating, using the processing device 904, an updated response-based ticket data, in accordance with some embodiments.

FIG. 13 illustrates a network diagram 1300 associated with methods and systems of authenticating a user based on a call, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

This present disclosure relates to telephone-based user interactions, specifically integrating AI-driven voice recognition, multi-factor authentication (MFA), ticketing systems, and CRM workflows. It addresses real-time authentication during a call, automatic ticket creation, post-call engagement via SMS, and intelligent routing, including after-hours escalation.

Conventionally, organizations use phone-based customer support for secure, real-time communications. However, common pain points exist such as:
1. Fragmented MFA: Current solutions often require users to leave the call to handle a separate MFA task, introducing friction and security gaps.
2. Multi-CRM Complexity: Enterprises may store tickets or user data across multiple CRM platforms, making it difficult to capture all call details (including voice recordings) in one place.
3. Limited Post-Call Engagement: Many systems provide no seamless method for continuing the conversation once the call ends-e.g., sending follow-up links or SMS instructions without requiring another contact attempt.
4. Inefficient Escalation: Handling after-hours calls or specialized requests often requires manual agent intervention. If no agent is available, the issue remains unresolved.
5. Voice Data Storage: While call recordings can be critical for audits and reference, existing solutions may not systematically attach them to tickets or user accounts, forcing manual steps that can introduce errors or security risks.

Further, as companies strive to reduce operational costs and improve the customer experience, there is a need for an end-to-end voice solution that authenticates users securely, integrates with multiple CRMs, automates ticket creation and voice recording attachment, routes call intelligently (even after hours), and provides post-call engagement (e.g., SMS follow-ups).

The present disclosure addresses these challenges through an AI-driven voice interaction system that (1) authenticates users in real time with MFA, (2) automatically creates and populates tickets across multiple CRMs, (3) attaches voice recordings/transcriptions to those tickets, (4) sets up ongoing communication channels (like SMS) after the call, and (5) routes calls based on context, availability, and schedules (e.g., after-hours workflows).

In some embodiments the present disclosure may include the following key features:
Voice-Based MFA: During a single phone call, an AI agent triggers an SMS or app-based challenge, captures the user's confirmation, and validates the response.
Dynamic Ticket Creation: Once a user is authenticated (or even if partially authenticated for a lower-tier inquiry), the system automatically opens or updates a ticket in one or more CRM systems, based on the customer's account or request type.
Voice Recording & Attachment: The invention records a call, optionally transcribes them, and appends recordings/transcripts to the relevant CRM tickets for audit and easy follow-up.
After-Hours Routing: The system checks schedules and call context (e.g., priority of the request) to route calls to the appropriate team or on-call personnel. If no live agent is available, the system can create an escalation ticket or prompt the user to continue via SMS or other channels.
Post-Call SMS Channel: Upon call termination or if the user opts in, the system can automatically send an SMS link or code to further validate identity, provide next steps, or gather feedback. This ensures continued engagement and reduces the need for repeated calls.

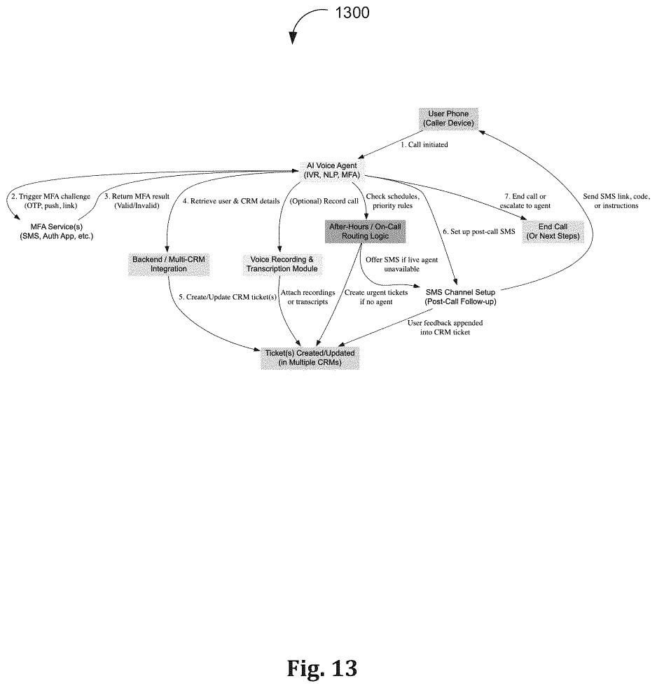

In accordance with FIG. 13, the elements associated with the present disclosure may defined as follows:
1. User Phone (Caller Device)
   The user-initiated or system-initiated call entry point.
2. AI Voice Agent/IVR System
   Handles speech recognition, conversational logic, and orchestrates MFA, ticket creation, routing, and SMS engagement.
3. MFA Service(s)
   External or built-in services that send/verify codes or push notifications (Duo, Microsoft Authenticator, SMS gateway).
4. Backend/Multi-CRM Integration
   Stores user/account data, call history, and connects to multiple CRM platforms. Automatically creates or updates tickets, attaches voice data, and logs after-hours routing decisions.
5. After-Hours Routing & On-Call
   Logic for time-based or context-based routing (urgent calls to on-call staff, standard calls to next business day queue).
6. SMS Engagement/Follow-Up
   A mechanism for continuing user interaction after the call, enabling further identity checks, request updates, or feedback prompts.

In some embodiments, the present disclosure may provide the following aspects:
A. AI-Driven Voice Interaction & MFA
1. Call Initiation
   The user calls the system or receives an inbound call. The AI voice agent greets the user, asks for basic identifiers (e.g., account number, name, phone number).
2. MFA Trigger
   If higher-level verification is needed, the AI sends a second-factor challenge via SMS OTP, push notification, or secure link.
   Real-Time Verification: The user stays on the call, reads back the code or confirms the push.
   Validation: The system checks the response with the MFA service, updating the user's session to “authenticated” if successful.
B. Ticket Creation & Multi-CRM Handling
1. CRM Selection/Integration
   Based on the user's account, product line, or request type, the system identifies which CRM(s) to update.
   For instance, if a user is part of two separate product lines, the system can create or update tickets in both CRMs simultaneously.
2. Voice Recording & Metadata
   The call is recorded from the moment the user connects or from a trigger point specified by policy.
   Once the call ends or at intervals during the call, the system attaches the voice recording (and optionally a transcript) to the relevant ticket(s).
3. Contextual Ticket Fields
   The AI can parse the user's verbal statements (using natural language processing) to fill in summary fields, issue descriptions, or reason codes.
   The user's MFA status, date/time, and other session details are also stored.
C. After-Hours Routing
1. Schedule Detection
   The system checks time-of-day or the user's priority level to determine if a live agent is available.
   If within normal business hours, the call may be routed to a support queue or continue in the AI IVR flow.
   If after hours or the issue is urgent, the system automatically:
      Routes to an on-call representative if available.
      Creates an “urgent” ticket in the CRM if no agent is available, logging the user's request.
      Offers post-call SMS to keep the user updated on the status.
D. Post-Call SMS Channel
1. SMS Setup
   If the user opts in or the system requires continued engagement (e.g., to provide additional documents or confirm an action), the AI triggers an SMS follow-up.
   This can happen immediately when the call ends or on a scheduled basis (e.g., once the agent has an update).
2. User Response
   The user can reply to the SMS or tap a link to provide more information, confirm an action, or finalize an authentication step.
   The user may report on the call quality, the experience with the AI, or any other issues.
3. Seamless Extension
   This avoids the need for a second phone call, reducing friction and improving user experience.
E. Additional Features
   Multi-Tenancy: The system may handle multiple organizations, each with unique CRMs and escalation paths.
   AI Transcription & Analysis: Automatic conversion of voice to text for quick scanning, sentiment analysis, or keyword tagging in the CRM.
   Biometric Voice Print: Optionally, advanced implementations could integrate voice biometrics as an additional factor for identity confirmation.
   Reporting & Analytics: The invention may provide dashboards showing call volumes, authentication success rates, after-hours escalations, reports, and logs.

In some embodiments, the present disclosure may provide the following advantages:
1. One-Call MFA & Ticketing: Users can authenticate, open a ticket, and get follow-up actions without leaving the phone call.
2. Multi-CRM Support: By integrating with multiple CRMs simultaneously, there is no need for duplicate entries or manual copy-paste of data.
3. After-Hours Automation: Automatically routes urgent requests or collects details for next-day follow-up, ensuring no user request is lost.
4. Recording & Evidence: Voice recordings or transcripts appended to CRM tickets offer a complete record for compliance or troubleshooting.
5. Continuous Engagement: Post-call SMS channels enhance user satisfaction and reduce phone queue congestion.

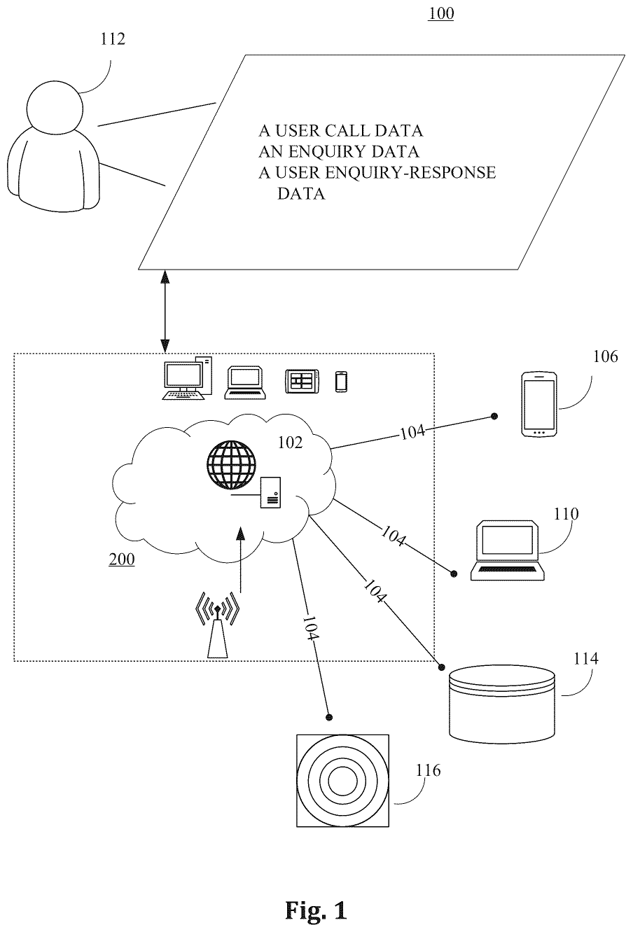

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

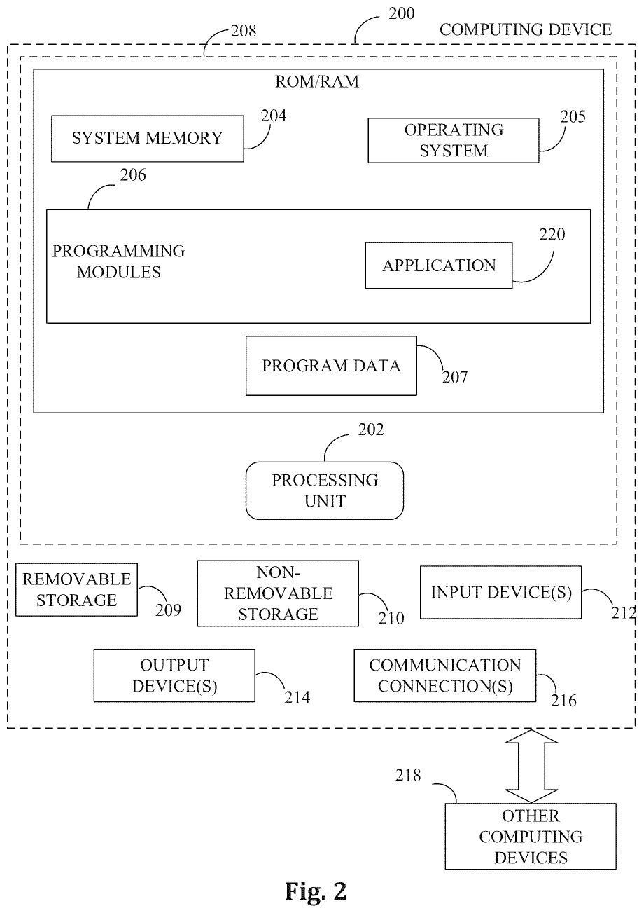

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices. Further, the embodiments of the disclosure allow the user to reset their password and create a new user profile.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

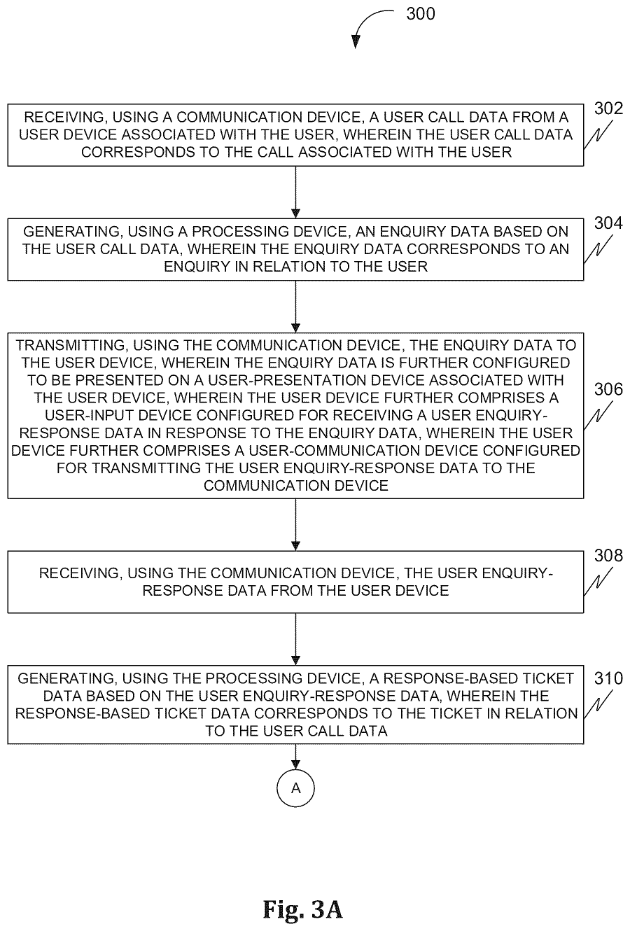

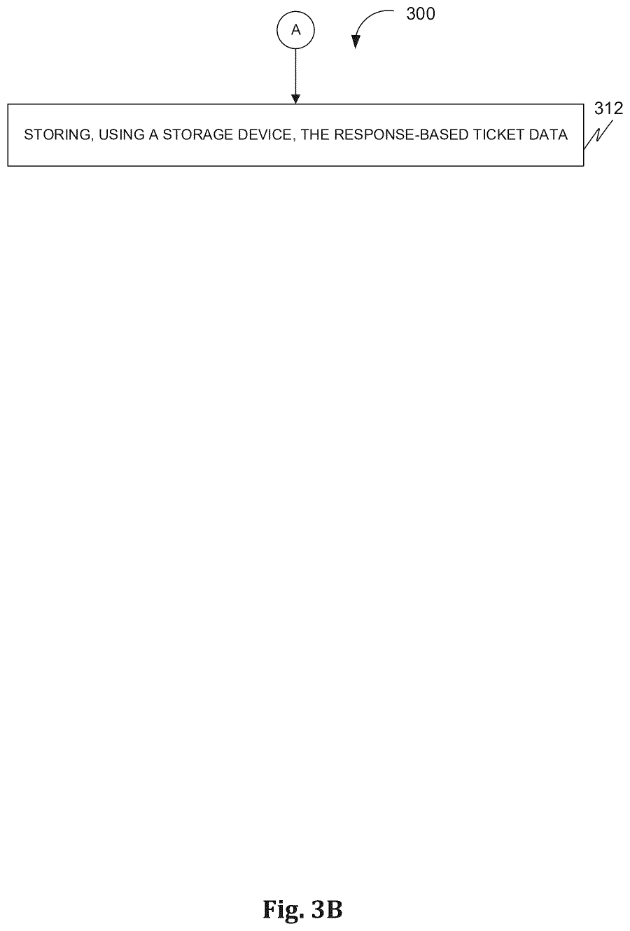

FIG. 3A and FIG. 3B illustrate a flowchart of a method 300 of generating a ticket associated with a user based on a call, in accordance with some embodiments.

Accordingly, the method 300 may include a step 302 of receiving, using a communication device 902, a user call data from a user device associated with the user. Further, the user call data corresponds to the call associated with the user. Further, the method 300 may include a step 304 of generating, using a processing device 904, an enquiry data based on the user call data. Further, the enquiry data corresponds to an enquiry in relation to the user. Further, the method 300 may include a step 306 of transmitting, using the communication device 902, the enquiry data to the user device. Further, the enquiry data may be further configured to be presented on a user-presentation device associated with the user device. Further, the user device further includes a user-input device which may be configured for receiving a user enquiry-response data in response to the enquiry data. Further, the user device further includes a user-communication device which may be configured for transmitting the user enquiry-response data to the communication device 902. Further, the method 300 may include a step 308 of receiving, using the communication device 902, the user enquiry-response data from the user device. Further, the method 300 may include a step 310 of generating, using the processing device 904, a response-based ticket data based on the user enquiry-response data. Further, the response-based ticket data corresponds to the ticket in relation to the user call data. Further, the method 300 may include a step 312 of storing, using a storage device 906, the response-based ticket data.

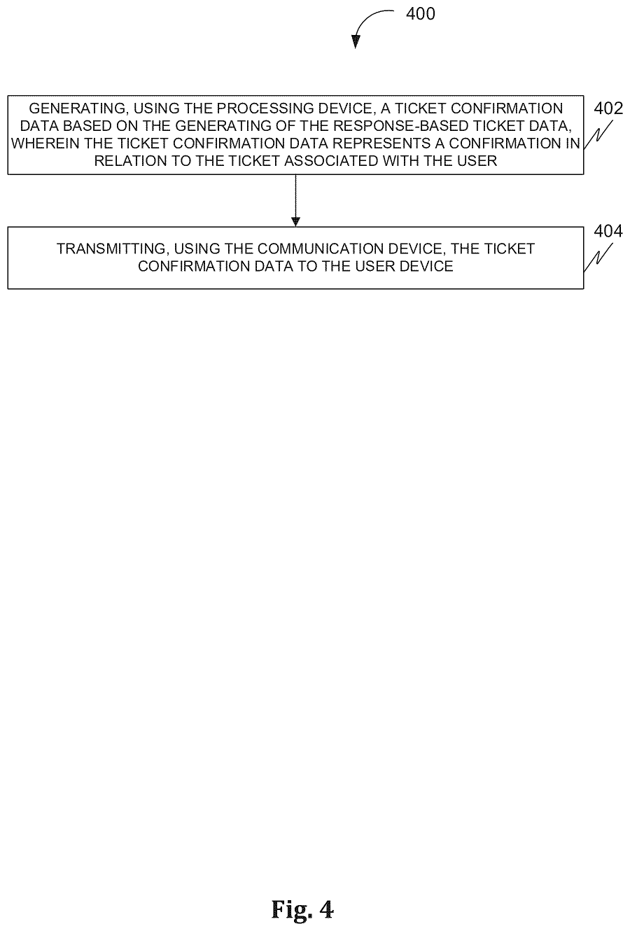

FIG. 4 illustrates a flowchart of a method 400 of generating a ticket associated with a user based on a call including generating, using the processing device 904, a ticket confirmation data, in accordance with some embodiments.

Further, in some embodiments, the method 400 further may include a step 402 of generating, using the processing device 904, a ticket confirmation data based on the generating of the response-based ticket data. Further, the ticket confirmation data represents a confirmation in relation to the ticket associated with the user. Further, in some embodiments, the method 400 further may include a step 404 of transmitting, using the communication device 902, the ticket confirmation data to the user device.

In some embodiments, the method 400 may further include determining, using the processing device 904, an authenticity of the user based on the user enquiry-response data. Further, the determining may be based on an AI module.

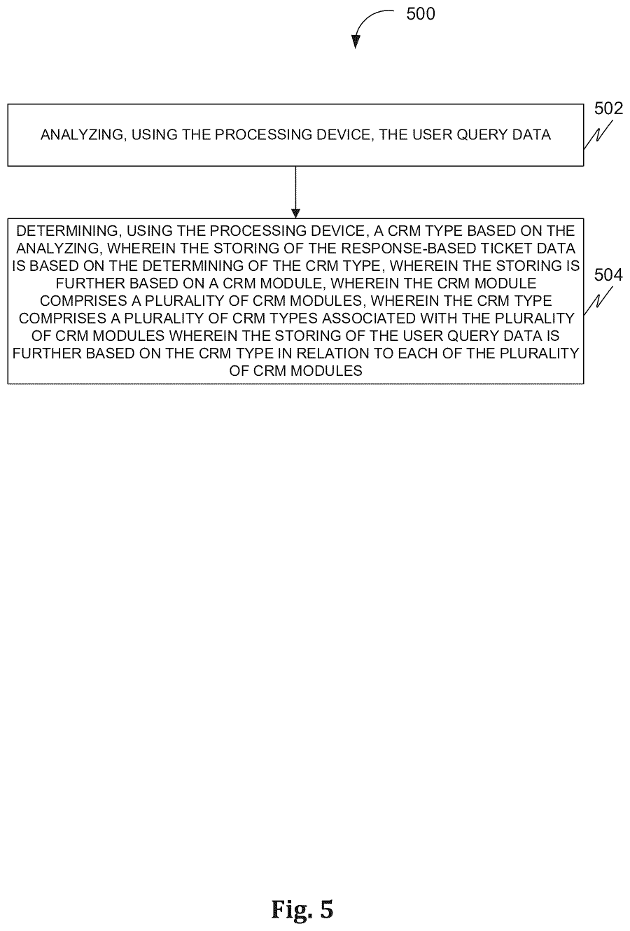

FIG. 5 illustrates a flowchart of a method 500 of generating a ticket associated with a user based on a call including determining, using the processing device 904, a CRM type, in accordance with some embodiments.

Further, in some embodiments, the user call data may include a user query data corresponding to a query associated with the user. Further, the generating of the response-based ticket data may be further based on the user query data. Further, the method 500 further may include a step 502 of analyzing, using the processing device 904, the user query data. Further, the user call data may include a user query data corresponding to a query associated with the user. Further, the method 500 further may include a step 504 of determining, using the processing device 904, a CRM type based on the analyzing. Further, the storing of the response-based ticket data may be based on the determining of the CRM type. Further, the storing may be further based on a CRM module. Further, the CRM module includes two or more CRM modules. Further, the CRM type includes two or more CRM types associated with the two or more CRM modules. Further, the storing of the user query data may be further based on the CRM type in relation to each of the two or more CRM modules.

In some embodiments, the method 500 may further include generating, using the processing device 904, a user call transcription data based on the user call data. Further, the user call transcription data corresponds to a transcription of the call associated with the user. Further, the response-based ticket data includes the user call transcription data.

In some embodiments, the method 500 may further include determining, using the processing device 904, one or more of a query type and a user-account type based on the user query data. Further, the query type corresponds to a type of the query. Further, the user-account type corresponds to a type of a user-account associated with the user. Further, the storage of the response-based ticket data may be further based on one or more of the user query type and the user-account type.

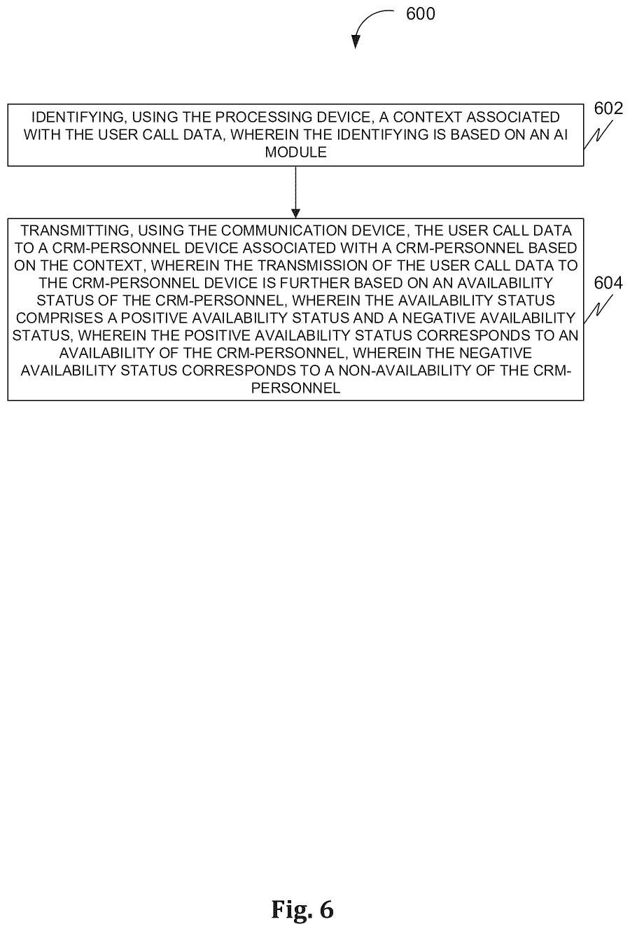

FIG. 6 illustrates a flowchart of a method 600 of generating a ticket associated with a user based on a call including identifying, using the processing device 904, a context associated with the user call data, in accordance with some embodiments.

Further, in some embodiments, the method 600 further may include a step 602 of identifying, using the processing device 904, a context associated with the user call data. Further, the identifying may be based on an AI module. Further, in some embodiments, the method 600 further may include a step 604 of transmitting, using the communication device 902, the user call data to a CRM-personnel device associated with a CRM-personnel based on the context. Further, the transmission of the user call data to the CRM-personnel device may be further based on an availability status of the CRM-personnel. Further, the availability status includes a positive availability status and a negative availability status. Further, the positive availability status corresponds to an availability of the CRM-personnel, may. Further, the negative availability status corresponds to a non-availability of the CRM-personnel.

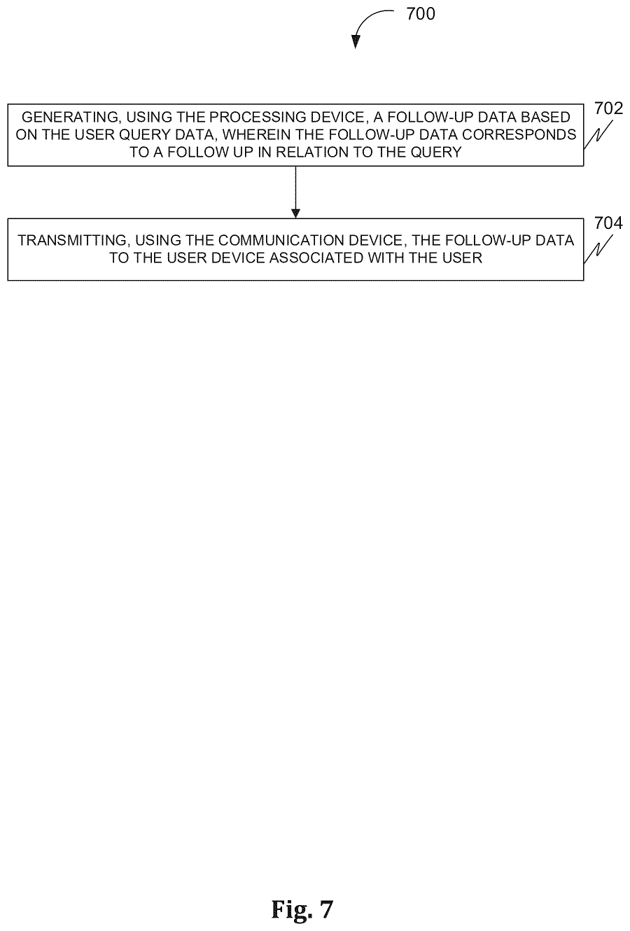

FIG. 7 illustrates a flowchart of a method 700 of generating a ticket associated with a user based on a call including generating, using the processing device 904, a follow-up data, in accordance with some embodiments.

Further, in some embodiments, the method 700 further may include a step 702 of generating, using the processing device 904, a follow-up data based on the user query data. Further, the follow-up data corresponds to a follow up in relation to the query. Further, in some embodiments, the method 700 further may include a step 704 of transmitting, using the communication device 902, the follow-up data to the user device associated with the user.

In some embodiments, the AI module includes a natural language processing AI module which may be configured for analyzing the user call transcription data. Further, the method 500 further comprising generating, using the processing device 904, a user call report data based on the analyzing of the user call transcription data. Further, the user call report data corresponds to a report based on the call. Further, the response-based ticket data includes the user call report data.

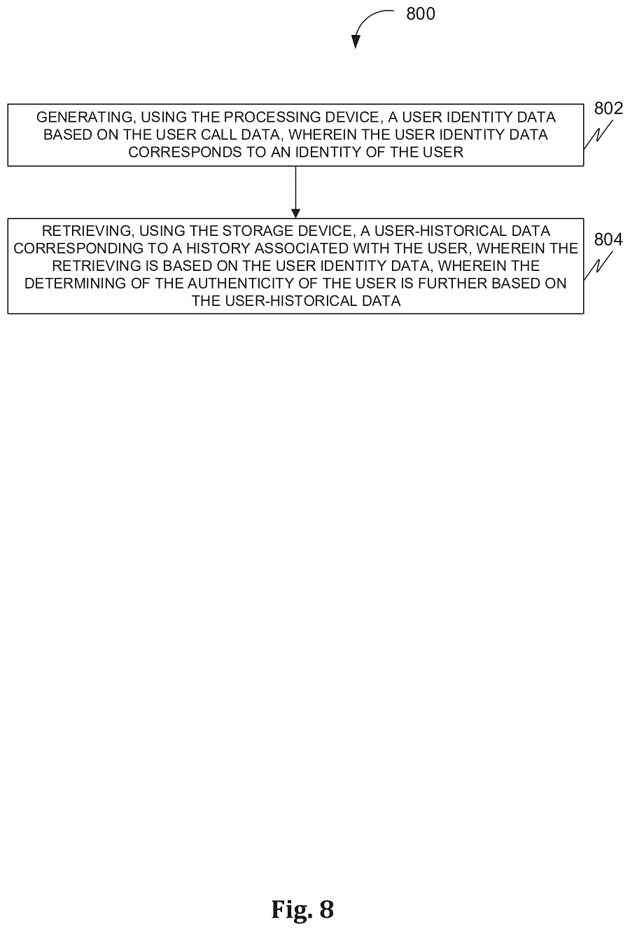

FIG. 8 illustrates a flowchart of a method 800 of generating a ticket associated with a user based on a call including retrieving, using the storage device 906, a user-historical data corresponding to a history associated with the user, in accordance with some embodiments.

Further, in some embodiments, the method 800 further may include a step 802 of generating, using the processing device 904, a user identity data based on the user call data. Further, the user identity data corresponds to an identity of the user. Further, in some embodiments, the method 800 further may include a step 804 of retrieving, using the storage device 906, a user-historical data corresponding to a history associated with the user. Further, the retrieving may be based on the user identity data. Further, the determining of the authenticity of the user may be further based on the user-historical data.

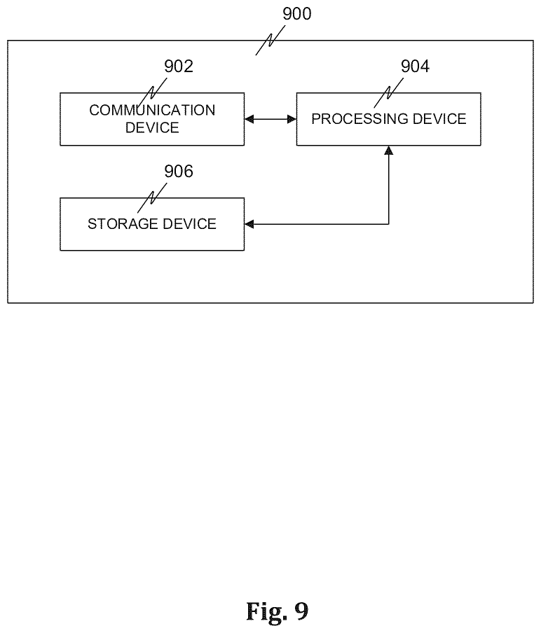

FIG. 9 illustrates a block diagram of a system 900 of generating a ticket associated with a user based on a call, in accordance with some embodiments.

Accordingly, the system 900 may include a communication device 902. Further, the communication device 902 may be configured for receiving a user call data from a user device associated with the user. Further, the user call data corresponds to the call associated with the user. Further, the communication device 902 may be configured for transmitting an enquiry data to the user device. Further, the enquiry data may be further configured to be presented on a user-presentation device associated with the user device. Further, the user device further includes a user-input device which may be configured for receiving a user enquiry-response data in response to the enquiry data. Further, the user device further includes a user-communication device which may be configured for transmitting the user enquiry-response data to the communication device 902. Further, the communication device 902 may be configured for receiving, using the communication device 902, the user enquiry-response data from the user device. Further, the system 900 may include a processing device 904. Further, the processing device 904 may be configured for generating the enquiry data based on the user call data. Further, the enquiry data corresponds to an enquiry in relation to the user. Further, the processing device 904 may be configured for generating a response-based ticket data based on the user enquiry-response data. Further, the response-based ticket data corresponds to the ticket in relation to the user call data. Further, the system 900 may include a storage device 906 which may be configured for storing the response-based ticket data.

In some embodiments, the processing device 904 may be further configured for generating a ticket confirmation data based on the generating of the response-based ticket data. Further, the ticket confirmation data represents a confirmation in relation to the ticket associated with the user. Further, the communication device 902 may be further configured for transmitting the ticket confirmation data to the user device.

In some embodiments, the processing device 904 may be further configured for determining an authenticity of the user based on the user enquiry-response data. Further, the determining may be based on an AI module.

Further, in some embodiments, the user call data may include a user query data corresponding to a query associated with the user. Further, the generating of the response-based ticket data may be further based on the user query data. Further, the processing device 904 may be further configured for analyzing the user query data. Further, the user call data may include a user query data corresponding to a query associated with the user. Further, the processing device 904 may be further configured for determining a CRM type based on the analyzing. Further, the storing of the response-based ticket data may be based on the determining of the CRM type. Further, the storing may be further based on a CRM module. Further, the CRM module includes two or more CRM modules. Further, the CRM type includes two or more CRM types associated with the two or more CRM modules. Further, the storing of the user query data may be further based on the CRM type in relation to each of the two or more CRM modules.

In some embodiments, the processing device 904 may be further configured for generating a user call transcription data based on the user call data. Further, the user call transcription data corresponds to a transcription of the call associated with the user. Further, the response-based ticket data includes the user call transcription data.

In some embodiments, the processing device 904 may be further configured for determining one or more of a query type and a user-account type based on the user query data. Further, the query type corresponds to a type of the query. Further, the user-account type corresponds to a type of a user-account associated with the user. Further, the storage of the response-based ticket data may be further based on one or more of the user query type and the user-account type.

In some embodiments, the processing device 904 may be further configured for identifying a context associated with the user call data. Further, the identifying may be based on an AI module. Further, the communication device 902 may be further configured for transmitting the user call data to a CRM-personnel device associated with a CRM-personnel based on the context. Further, the transmission of the user call data to the CRM-personnel device may be further based on an availability status of the CRM-personnel. Further, the availability status includes a positive availability status and a negative availability status. Further, the positive availability status corresponds to an availability of the CRM-personnel, may. Further, the negative availability status corresponds to a non-availability of the CRM-personnel.

In some embodiments, the processing device 904 may be further configured for generating a follow-up data based on the user query data. Further, the follow-up data corresponds to a follow up in relation to the query. Further, the communication device 902 may be further configured for transmitting the follow-up data to the user device associated with the user.

In some embodiments, the AI module includes a natural language processing AI module which may be configured for analyzing the user call transcription data. Further, the system 900 further comprising generating, using the processing device 904, a user call report data based on the analyzing of the user call transcription data. Further, the user call report data corresponds to a report based on the call. Further, the response-based ticket data includes the user call report data.

In some embodiments, the processing device 904 may be further configured for generating a user identity data based on the user call data. Further, the user identity data corresponds to an identity of the user. Further, the storage device 906 may be further configured for retrieving a user-historical data corresponding to a history associated with the user. Further, the retrieving may be based on the user identity data. Further, the determining of the authenticity of the user may be further based on the user-historical data.

In some embodiments, the generating of the response-based ticket data may be further based on an AI module.

In some embodiments, the user enquiry-response data includes a vocal input data corresponding to vocal input associated with the user.

In some embodiments, the enquiry data includes a SMS data corresponding to a SMS provisioned to the user.

In some embodiments, the enquiry data includes an application-based challenge data corresponding to a challenge associated with an application comprised in the user device.

In some embodiments, the challenge includes a user input in relation to the application.

In some embodiments, the application includes a multi-factor authenticator.

In some embodiments, the multi-factor authenticator includes one or more of a Microsoft authenticator and Duo authenticator.

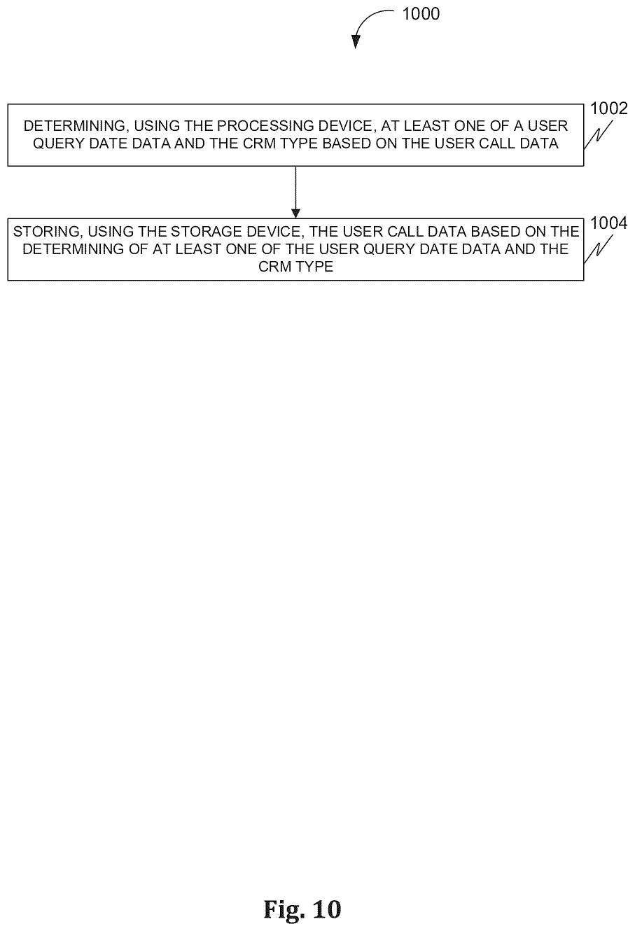

FIG. 10 illustrates a flowchart of a method 1000 of generating a ticket associated with a user based on a call including determining, using the processing device 904, at least one of a user query date data and the CRM type, in accordance with some embodiments.

Further, in some embodiments, the method 1000 further may include a step 1002 of determining, using the processing device 904, one or more of a user query date data and the CRM type based on the user call data. Further, in some embodiments, the method 1000 further may include a step 1004 of storing, using the storage device 906, the user call data based on the determining of one or more of the user query date data and the CRM type.

In some embodiments, the method 600 may further include generating, using the processing device 904, an extended query-based ticket data based on the negative availability status associated with the CRM-personnel.

In some embodiments, the follow-up data includes a SMS link data corresponding to a SMS link associated with the follow up in relation to the query.

In some embodiments, the follow-up data includes an activity code data corresponding to an activity code associated with the follow up.

In some embodiments, the activity code data includes an additional identity validation request data corresponding to a request for additional identity validation in relation to the user.

In some embodiments, the activity code data includes a query resolution step data corresponding to a query resolution step associated with the query.

In some embodiments, the activity code data includes a user-feedback request data corresponding to a request for user feedback in relation to the query resolution step.

In some embodiments, the user enquiry-response data includes one or more of a user account number data, user name data and user phone number data. Further, the user account number data corresponds to an account number associated with the user. Further, the user name data corresponds to a name associated with the user. Further, the user phone number data corresponds to a phone number associated with the user.

In some embodiments, the user enquiry-response data includes a user confirmation data corresponding to a vocal-confirmation of the enquiry data.

In some embodiments, the user call report data includes a summary data corresponding to a summary of the call associated with the user.

In some embodiments, the method 500 may further include determining, using the processing device 904, a priority level associated with the query. Further, the generating of the response-based ticket data may be further based on the priority level.

In some embodiments, determining the authenticity of the user may be further based on a vocal biometric framework. Further, the vocal biometric framework may be based on a vocal characteristic associated with the vocal input from the user.

In some embodiments, the vocal characteristic includes one or more of a vocal pitch, a vocal tone, a vocal cadence and a speaking pattern associated with the user.

In some embodiments, the user device includes a mobile phone.

In some embodiments, the generating of the enquiry data may be further based on an IVR module.

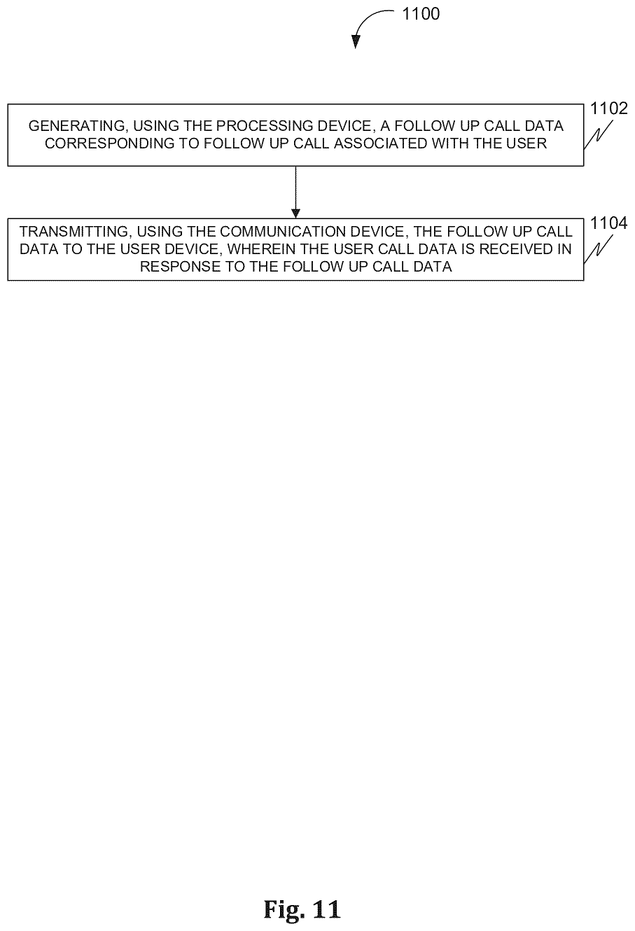

FIG. 11 illustrates a flowchart of a method 1100 of generating a ticket associated with a user based on a call including generating, using the processing device 904, a follow up call data corresponding to follow up call associated with the user, in accordance with some embodiments.

Further, in some embodiments, the method 1100 further may include a step 1102 of generating, using the processing device 904, a follow up call data corresponding to follow up call associated with the user. Further, in some embodiments, the method 1100 further may include a step 1104 of transmitting, using the communication device 902, the follow up call data to the user device. Further, the user call data may be received in response to the follow up call data.

In some embodiments, the user-input device includes a user-side microphone includes in the user device.

In some embodiments, the user presentation device includes a user-side speaker comprised in the user device.

In some embodiments, the ticket confirmation data includes a ticket reference number data corresponding to a reference number associated with the ticket.

In some embodiments, the AI module includes a rule-based AI module corresponding to the AI module which may be configured to perform the generating response-based ticket data based on a pre-described rule.

In some embodiments, the AI module which may be configured to be trained based on each of the user call transcription data, the user call report data and the follow-up data.

In some embodiments, the method 500 may further include storing, using the storage device 906, the user call report data.

In some embodiments, the response-based ticket data includes a pending ticket data corresponding to a pending ticket associated with the user. Further, the pending ticket data further corresponds to one or more of an incomplete user enquiry-response data and an improper user enquiry-response data. Further, the ticket confirmation data includes a pending ticket confirmation data.

In some embodiments, the pending ticket confirmation data includes a rectification instruction data corresponding to an instruction associated with the rectification of one or more of the incomplete user enquiry-response data and the improper user enquiry-response data.

In some embodiments, the method 400 may further include generating, using the processing device 904, a risk evaluation data based on the pending ticket data. Further, the risk evaluation data corresponds to a risk factor associated with the user. Further, the risk factor includes one or more of a user location, user call history and user call context. Further, the generation of the risk evaluation data may be further based on an AI module.

In some embodiments, the determining of the CRM type may be further based on the AI module.

In some embodiments, the user call data includes a user query data corresponding to a query associated with the user. Further, the context includes one or more of a user query priority level, a user history and a query resolution time. Further, the user query priority level corresponds to a priority level associated with the query. Further, the user history corresponds to a previous interaction associated with the user. Further, the query resolution time corresponds to a time required for a resolution of the query associated with the user.

In some embodiments, the transmitting of the user call data to the CRM personnel may be further based on a call scheduling module which may be configured for scheduling the call based on the context.

In some embodiments, the CRM type includes two or more CRM types associated with the two or more CRM modules. Further, the storing of the user call data may be further based on the determining of the two or more CRM types.

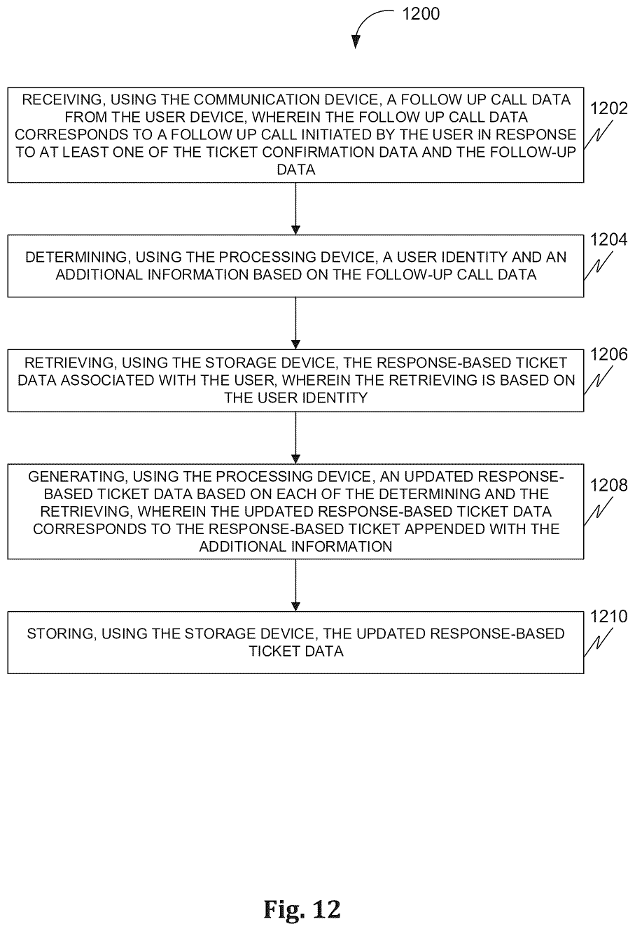

FIG. 12 illustrates a flowchart of a method 1200 of generating a ticket associated with a user based on a call including generating, using the processing device 904, an updated response-based ticket data, in accordance with some embodiments.

Further, in some embodiments, the method 1200 further may include a step 1202 of receiving, using the communication device 902, a follow up call data from the user device. Further, the follow up call data corresponds to a follow up call initiated by the user in response to one or more of the ticket confirmation data and the follow-up data. Further, in some embodiments, the method 1200 further may include a step 1204 of determining, using the processing device 904, a user identity and an additional information based on the follow-up call data. Further, in some embodiments, the method 1200 further may include a step 1206 of retrieving, using the storage device 906, the response-based ticket data associated with the user. Further, the retrieving may be based on the user identity. Further, in some embodiments, the method 1200 further may include a step 1208 of generating, using the processing device 904, an updated response-based ticket data based on each of the determining and the retrieving. Further, the updated response-based ticket data corresponds to the response-based ticket appended with the additional information. Further, in some embodiments, the method 1200 further may include a step 1210 of storing, using the storage device 906, the updated response-based ticket data.

FIG. 13 illustrates a network diagram 1300 associated with methods and systems of generating a ticket associated with a user based on a call, in accordance with some embodiments.

In some embodiments, each of the determining of the user identity and an additional information and the generating of the updated response-based ticket data may be based on the AI module.

In some embodiments, the generating of the follow-up data may be based on an AI-based conversation bot corresponding to a software program which may be configured for facilitating the follow-up.

Although the invention has been explained in relation to its preferred embodiment, it is to be understood that many other possible modifications and variations can be made without departing from the spirit and scope of the invention as hereinafter claimed.

What is claimed is:

1. A system for managing a user interaction during a telephone call, comprising:
a communication device configured to receive user call data from a user device during the telephone call;
a processing device configured to:
analyze the user call data to identify user query data;
initiate a multi-factor authentication (MFA) challenge during the telephone call by generating enquiry data comprising at least one of an SMS challenge, an application-based challenge, or a vocal prompt;
validate user enquiry-response data received during the telephone call to authenticate the user;
determine a customer-relationship-management (CRM) type based on the user query data;
generate response-based ticket data associated with the telephone call; and
attach at least one of a call recording, a call transcription, or a call report to the response-based ticket data;
a storage device configured to store the response-based ticket data in one or more CRM modules based on the CRM type;
wherein the processing device is further configured to determine an after-hours routing action based on at least one contextual variable comprising time, user priority, or personnel availability, and to generate follow-up data for transmission to the user device after the telephone call.

2. A method for generating a ticket associated with a user based on a telephone call, the method comprising:
receiving, using a communication device, user call data from a user device during the telephone call;
generating, using a processing device, enquiry data comprising an MFA challenge;
transmitting the enquiry data to the user device;
receiving user enquiry-response data during the telephone call;
determining, using the processing device, an authenticity of the user based on the user enquiry-response data;
analyzing user query data included in the user call data;
determining a CRM type based on the analyzing;
generating response-based ticket data based on the user enquiry-response data and the user query data;
generating at least one of a call transcription, a call report, or a call recording associated with the telephone call;
storing the response-based ticket data in one or more CRM modules based on the CRM type; and
generating follow-up data for post-call communication with the user.

3. The system of claim 1, wherein the user enquiry-response data comprises a vocal confirmation of the MFA challenge.

4. The system of claim 1, wherein determining the authenticity of the user further comprises evaluating a vocal biometric characteristic selected from vocal pitch, vocal tone, vocal cadence, or speaking pattern.

5. The method of claim 2, wherein the MFA challenge comprises an SMS one-time-password transmitted to the user device.

6. The method of claim 2, wherein determining the authenticity of the user further comprises comparing the user enquiry-response data with user-historical data retrieved from the storage device.

7. The system of claim 1, wherein the processing device includes a natural language processing module configured to analyze the call transcription to generate a call report.

8. The method of claim 2, further comprising generating a user call report based on NLP analysis of the call transcription.

9. The system of claim 1, wherein the processing device is configured to determine a query type or user-account type based on the user query data.

10. The system of claim 1, wherein the CRM type comprises two or more CRM types associated with two or more CRM modules, and the response-based ticket data is stored in each CRM module.

11. The method of claim 2, wherein storing the response-based ticket data comprises storing the user query data in each CRM module corresponding to the CRM type.

12. The system of claim 1, wherein the response-based ticket data includes metadata comprising MFA status, date, time, and call context.

13. The system of claim 1, wherein the contextual variable comprises an availability status of CRM personnel.

14. The method of claim 2, further comprising transmitting the user call data to a CRM-personnel device based on the availability status.

15. The system of claim 1, wherein the processing device is configured to generate an extended query-based ticket when the availability status is negative.

16. The method of claim 2, wherein the follow-up data comprises an SMS link for continued identity validation or request completion.

17. The system of claim 1, wherein the follow-up data comprises an activity code representing at least one of an additional identity validation request, a query resolution step, or a user-feedback request.

18. The method of claim 2, wherein the follow-up data is transmitted automatically upon termination of the telephone call.

19. The system of claim 1, wherein the call recording is initiated at a policy-defined trigger point during the telephone call.

20. The method of claim 2, wherein the call transcription is appended to the response-based ticket data prior to storage.
